(19) United States
(12) Patent Application Publication
(10) Pub. No.: US 2013/0133467 A1
(43) Pub. Date: May 30, 2013

(54) SYSTEMS AND METHODS FOR CONFIGURING BICYCLE HANDLEBAR GRIP ASSEMBLIES

(71) Applicant: Clinton N. Slone, San Francisco, CA (US)

(72) Inventor: Clinton N. Slone, San Francisco, CA (US)

(21) Appl. No.: 13/688,164

(22) Filed: Nov. 28, 2012

Related U.S. Application Data
(60) Provisional application No. 61/564,823, filed on Nov. 29, 2011.

(51) Int. Cl. B62K 21/26

(52) U.S. Cl. CPC B62K 21/26
USPC 74/551.9

(57) ABSTRACT

The present invention relates to systems and methods for configuring handlebar grip assemblies useful in associate with handlebars of pedicycles, such as a bicycle. The grip assembly includes a plurality of stretchable grip rings, wherein each of the grip rings is substantially shorter than half of a desired grip length of the handlebar. The internal diameter of each grip ring is smaller than an external diameter of the handlebar. In some embodiments, the grip rings nest and interlock with adjacent grip rings. In other embodiments, the grip rings overlap in a staggered manner with adjacent grip rings. Grips rings can have different shapes, profiles and/or sizes. Grip rings can also have a variety of colors and/or textures.

### CROSS REFERENCE TO RELATED APPLICATIONS

This non-provisional application claims the benefit of provisional application No. 61/564,823 filed on Nov. 29, 2011, entitled “Systems and Methods for Configuring Bicycle Handlebar Grip Assemblies”, which application is incorporated herein in its entirety by this reference.

### BACKGROUND

The present invention relates to systems and methods for configuring handlebar grip ring assemblies with a plurality of grip rings, preferably made using a stretchable material.

Conventional bicycle grips are typically molded from a single-piece elastomeric tubing. These grips are long enough to provide necessary surface area for an average adult to grip with a full hand. They are usually sold in sets of two, one right hand grip and one left hand grip. Frequently the inner diameters of the grips are slightly less than the handlebar outer diameter. This causes the grip to constrict around the handlebar to hold the grip in place. Installing conventional grips can be difficult due to friction caused by the long constricting tube stretching over the handlebar. It is common practice to use a drying lubricant, such as hair spray or an adhesive, to make installation of the grips on handlebars easier.

Changing such single-piece grips require forceful removal of the entire grip from the handlebar, often resulting in permanent damage to the grip. Such grips are also not user-configurable, in that one has to decide grip characteristics, e.g., color, size, texture, prior to purchase.

It is therefore apparent that an urgent need exists for reliable and user-configurable grip systems that are also easy to install and remove. Such improved grip systems will enable the user to at-will reconfigure grips according to hand size, riding position, riding environment and/or aesthetic preference.

### SUMMARY

To achieve the foregoing and in accordance with the present invention, systems and methods for configuring handlebar grips are provided. In particular, systems and methods for configuring handlebar grip ring assemblies with a plurality of stretchable grip rings are provided.

In one embodiment, a user-configurable handlebar grip assembly useful in associate with a handlebar of a pedicycle, such as a bicycle, is provided. The grip assembly includes a plurality of stretchable grip rings. The width of the grip rings is substantially shorter than half of the handlebar's grip length. The internal diameter of each grip ring is smaller than an external diameter of the handlebar.

In some embodiments, the grip rings nest and interlock with adjacent grip rings. In other embodiments, the grip rings overlap in a staggered manner with adjacent grip rings. Grips rings can have different shapes, profiles and/or sizes. Grip rings can also have a variety of colors and/or textures.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are perspective and cross-sectional views showing one embodiment of a configurable handlebar grip assembly with nesting grip rings installed on a handlebar in accordance with the present invention;

FIG. 2 is a perspective view of a nesting grip ring for the grip assembly of FIG. 1A, while FIG. 3 shows the grip assembly of FIG. 1A with the last grip ring before installation;

FIG. 4 is a perspective view showing multiple grip rings of FIG. 2 installed on a handlebar with a twist grip shifter;

FIGS. 5A and 5B are perspective and cross-sectional views illustrating another embodiment of a configurable handlebar grip assembly with non-nesting grip rings installed on a handlebar;

FIGS. 6A and 6B are perspective and cross-sectional views showing yet another embodiment of a configurable handlebar grip assembly with interlocking grip rings installed on a handlebar;

FIGS. 7A and 7B are perspective and cross-sectional views illustrating another embodiment of a configurable handlebar grip assembly with interlocking and overlapping grip rings installed on a handlebar, while FIG. 8 shows one of the interlocking and overlapping grip rings for the grip assembly of FIG. 7A;

FIG. 9 is a perspective view showing yet another embodiment of a configurable handlebar grip assembly with a plurality of grip rings including at least one angled grip ring, while FIG. 10 is a side view of at least one angled grip ring for the grip assembly of FIG. 9; and

FIG. 11 is a perspective view showing another embodiment of a configurable hybrid handlebar grip assembly with a variety of grip rings installed on a handlebar.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

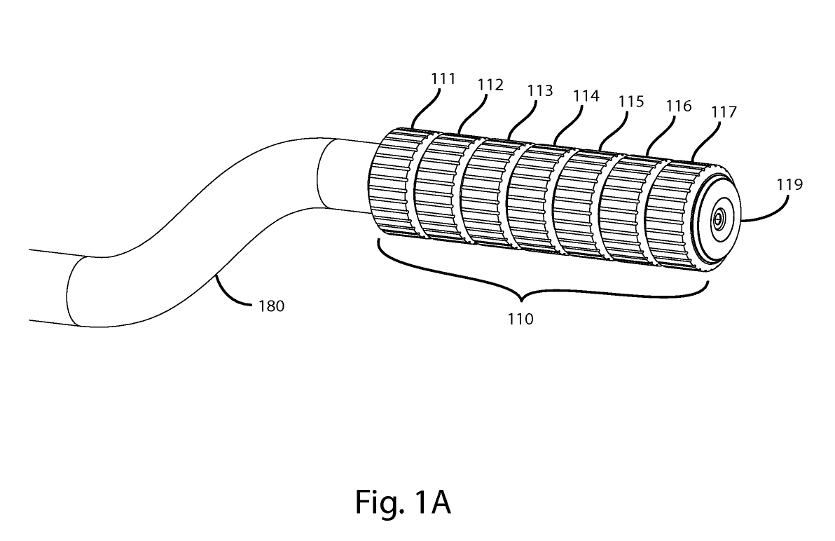

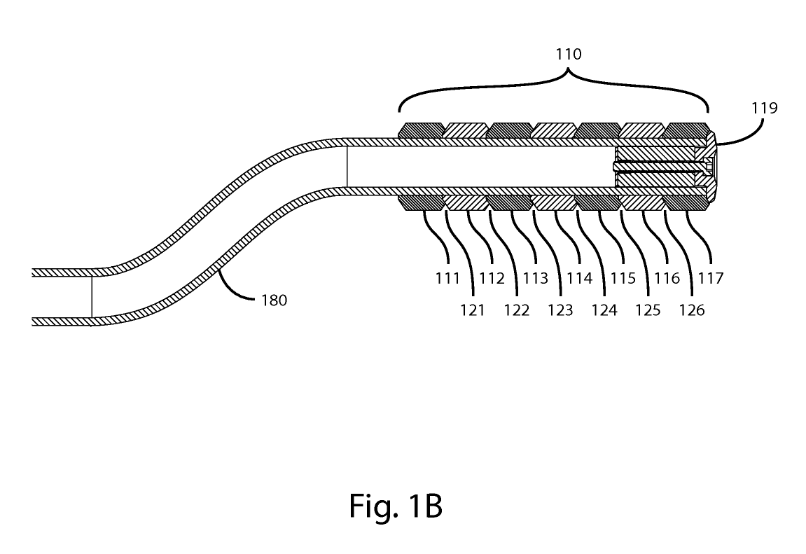

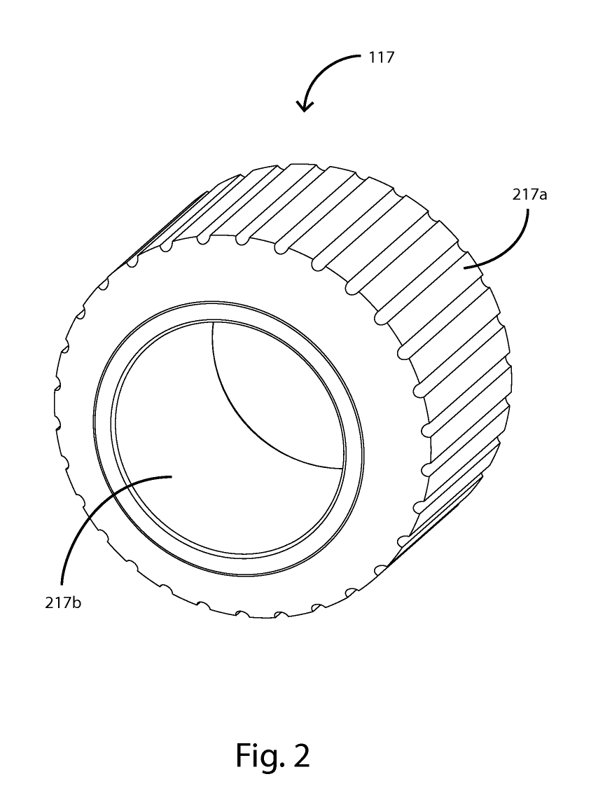

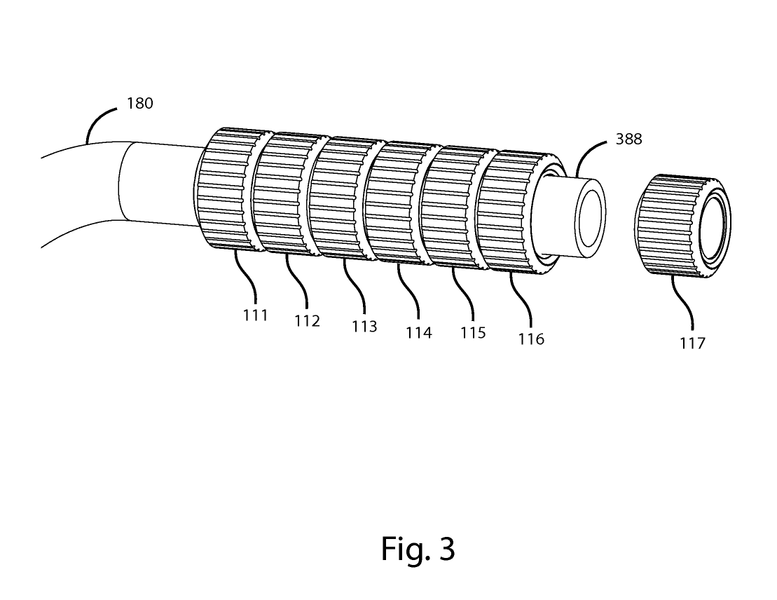

The present invention relates to systems and methods for configuring handlebar grip ring assemblies with a plurality of grip rings. To facilitate discussion, FIGS. 1A and 1B are perspective and cross-sectional views, respectively, of a configurable handlebar grip assembly 110 having a plurality of nesting grip rings 111, 112, 113 . . . 117 installed on a handlebar 180, in accordance with one embodiment of the present invention. A perspective view of an exemplary nesting grip ring 117 is shown in FIG. 2.

As shown in cross-sectional view of FIG. 1B, adjacent grip rings, e.g., rings 111, 112, are nested in a manner so that the grip portion of handlebar 180 is substantially obscured from view, with the total number of required grip rings dependant on the grip length of the handlebar 180 to be covered. In this embodiment, because of the chamfering of rings 111, 112, 113 . . . 117, grooves 121, 122 . . . 126 are created between adjacent rings, e.g. groove 121 is created between rings 111 and 112. The profile of grooves 121, 122, 126 are sufficiently deep and wide so as to increase physical communication, such as increased grippiness and tactile feedback, between the user's hands and the overall grip ring assembly 110.

In this embodiment, grip rings 111, 112, 113 . . . 117 can be made from a variety of suitable stretchable materials including pliable elastomers such as Teknor Apex Monoprene. Grip rings 111, 112, 113 . . . 117 can be installed one at a time in any order by stretching and sliding them onto handlebar 180, one after another. FIG. 3 shows the grip assembly 110 with grip rings 111, 112, 113 . . . 116 installed, with the last grip ring 117 ready to be installed onto an end portion 388 of handlebar 180. After the entire nested plurality of grip rings 111, 112, 113 . . . 117 are installed on handlebar 180, the grip ring assembly 110 can be further secured in place on handlebar 180 by an optional end cap 119. End caps are also commonly known as end plugs to one skilled in the art.

Since the external diameter of most standard bicycle handlebars are generally about 22-24 mm in diameter, the internal diameter of the stretchable grip rings, e.g., the diameter of internal ring surface 217b, should range from approximately 15 mm to approximately 20 mm, to ensure a secure fit on handlebar 180. Hence, as long as the grip ring internal diameters are consistent with the external diameter of handlebar 180, a wide variety of grip rings with different combination of characteristics, including colors, widths, and external diameters and textures, can be combined to create a unique assembly of grip rings with functionality and/or esthetics in mind. For example, as shown in FIG. 2, grip ring 117 includes an external ring surface 217a with ribbed texture.

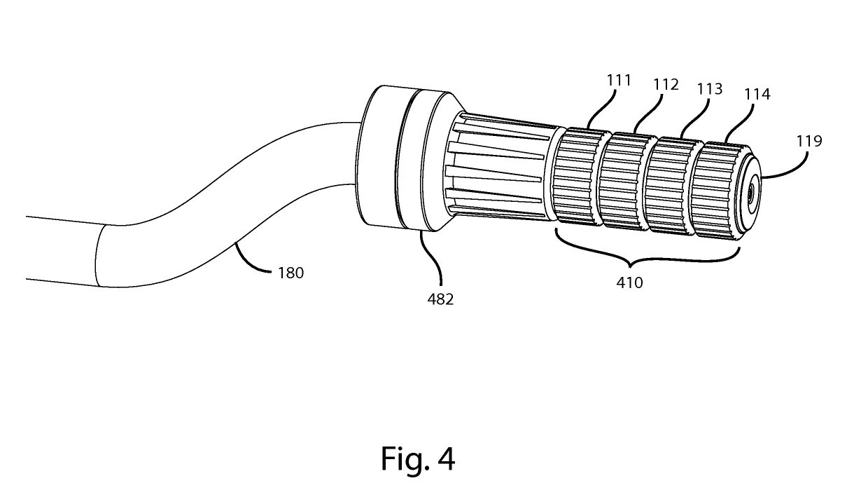

Referring now to FIG. 4, a perspective view of a grip ring assembly 410 comprising of multiple grip rings 111, 112, 113, 114 installed on handlebar 180 having a twist grip shifter 482 is shown. Since most grip shifters such as shifter 482 include a relatively short gripping area, grip assembly 410 provides additional gripping surface for the rider, thereby ensuring an adequate and safe grip on handlebar 180 during maneuvers. An optional end cap 119 also helps prevent grips rings 111, 112, 113, 114 from inadvertently sliding off handlebar 180 during vigorous use.

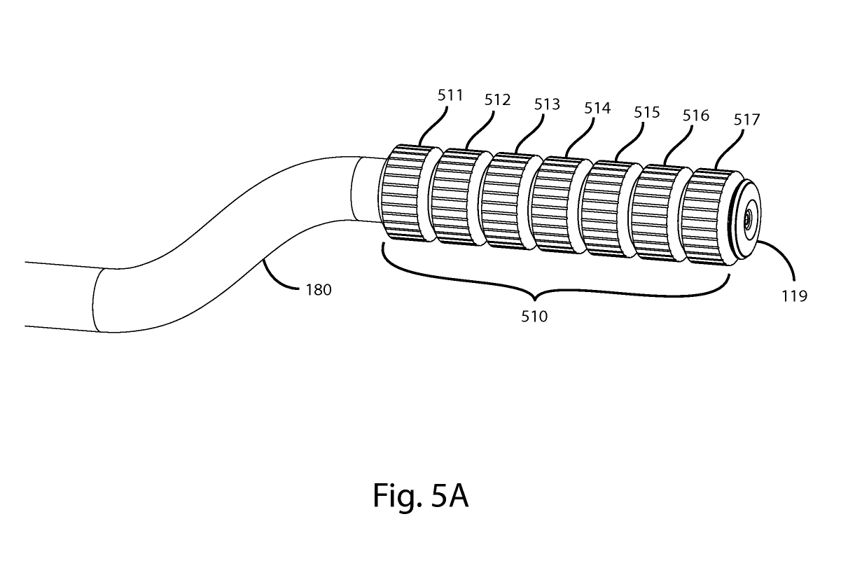

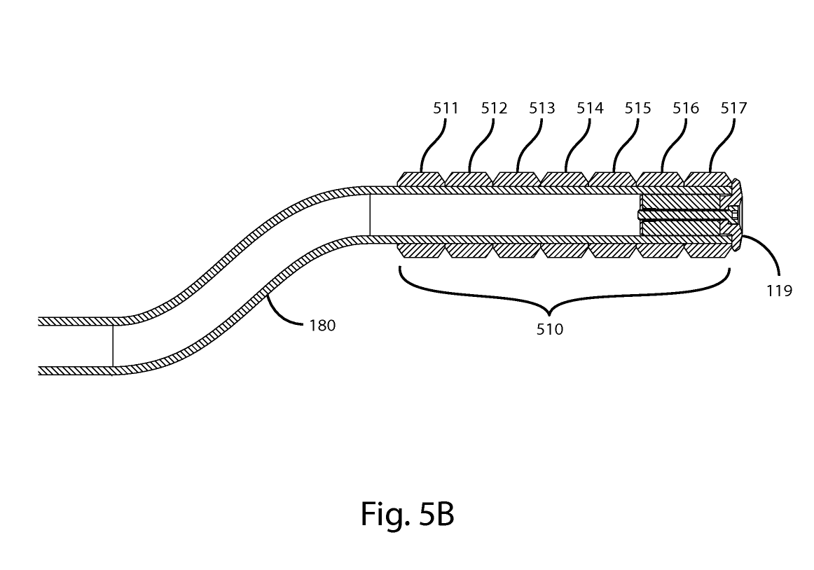

FIGS. 5A and 5B are perspective and cross-sectional views, respectively, illustrating another configurable handlebar grip assembly 510 with non-nesting grip rings 511, 512, 513 . . . 517 installed on handlebar 180. An optional end cap 119 secures assembly 510 and also helps prevent grips rings 511, 512, 513 . . . 517 from inadvertently sliding off handlebar 180 during vigorous use. Advantages of the non-nesting configuration of assembly 510 include ease of installation due to symmetry of design (can be installed in either orientation), and also increased compatibility with other manufacturer's grips or grip shifters.

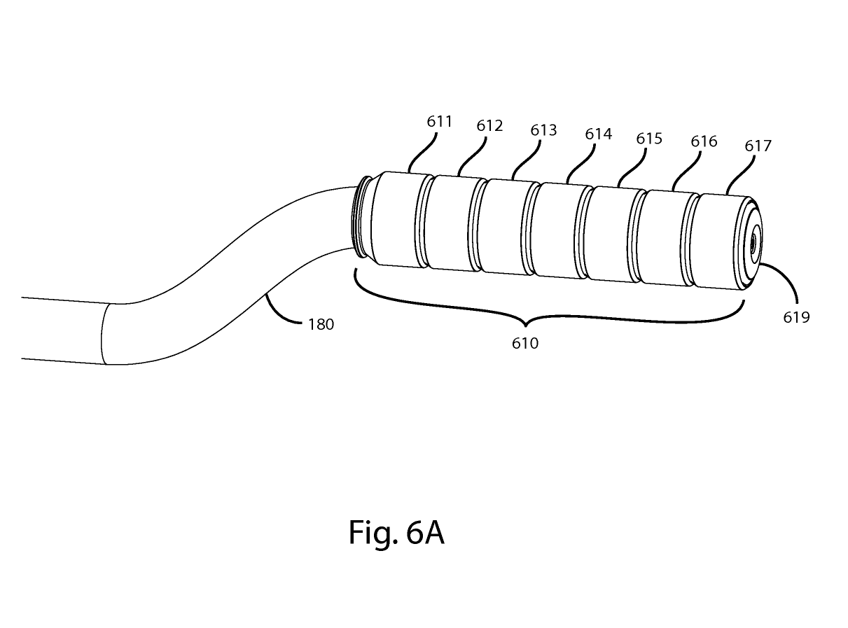

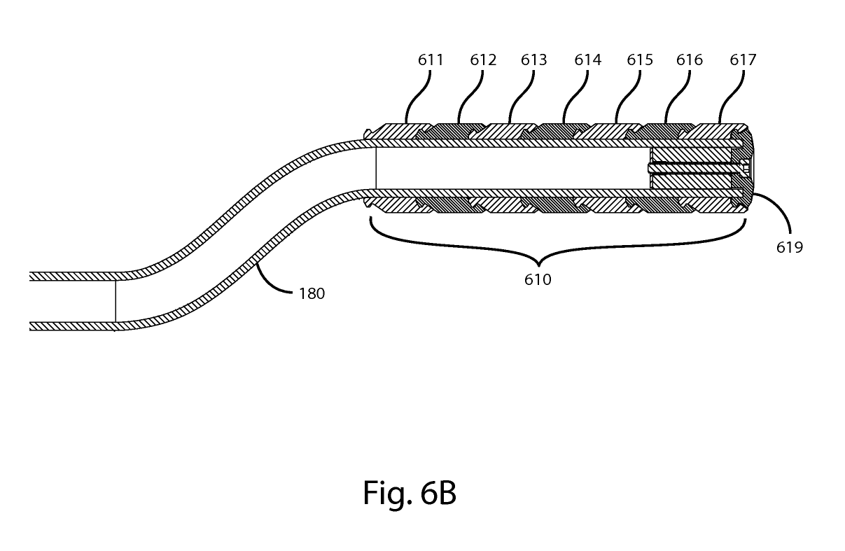

FIGS. 6A and 6B are perspective and cross-sectional views showing yet another exemplary configurable handlebar grip assembly 610 with interlocking grip rings 611, 612, 613 . . . 617 installed on handlebar 180. In this embodiment, grip rings 611, 612, 613 . . . 617 and end cap 619 include interlocking ridges, e.g., ridges 611a, 612a of rings 611, 612, configured to overlap adjacent grip ring(s) thereby securely interlock the plurality of rings of grip assembly 610 together. This overlapping interlocking feature helps to hold assembly 610 together whenever aggressive gripping forces are applied by the user during cycling.

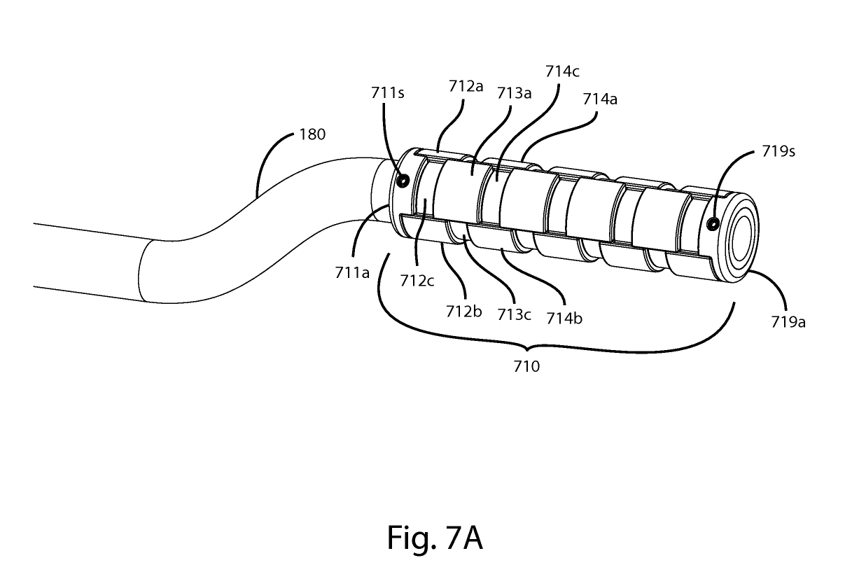

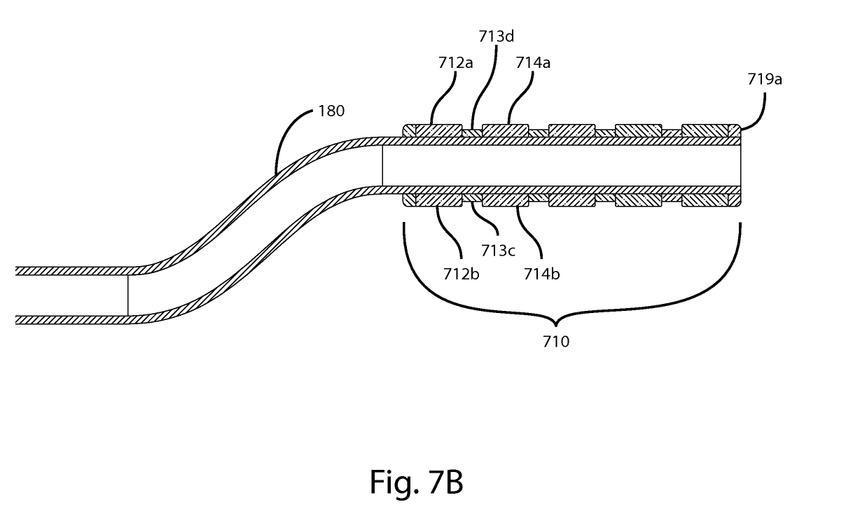

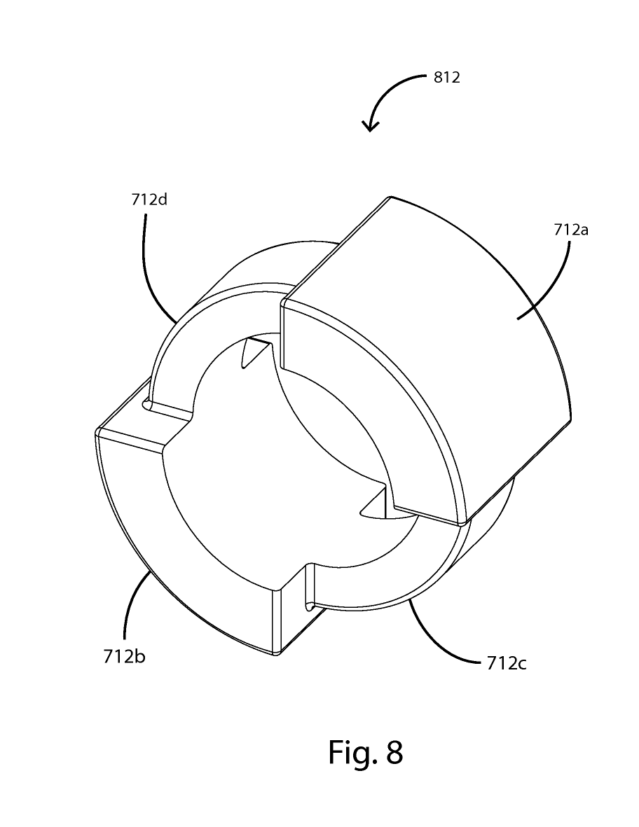

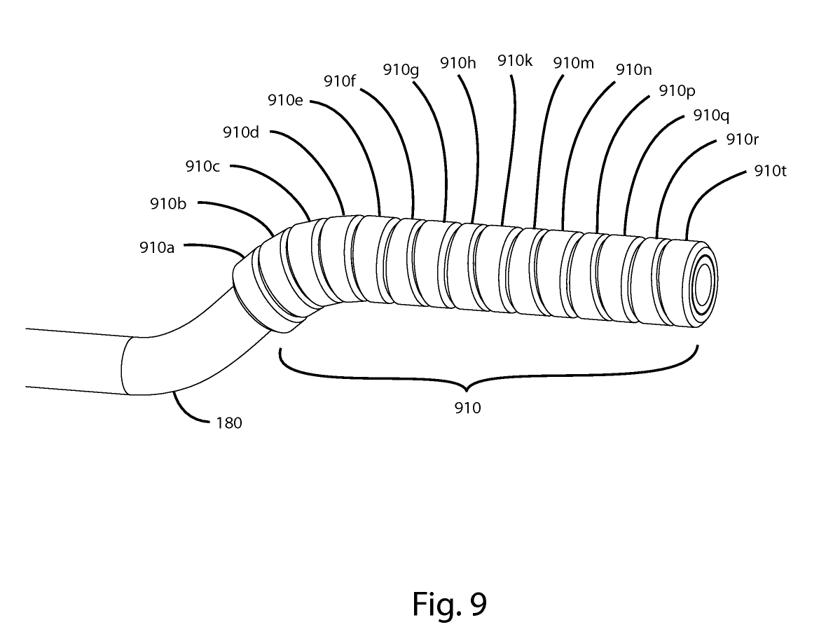

FIGS. 7A and 7B are perspective and cross-sectional views illustrating yet another configurable handlebar grip assembly 710 with a plurality of interlocking and overlapping grip rings installed on handlebar 180. FIG. 8 shows an exemplary interlocking and overlapping grip ring 812 of assembly 710. Grip ring 812 includes a first pair of ring segments 712a, 712b and a second pair of ring segments 712c, 712d.

In this embodiment, adjacent grip rings of assembly 710 interlock in an overlapping and staggered configuration. For example, first grip ring segment 712a interlocks with second grip ring segment 713d, which in turn interlocks with third grip ring segment 714a, as shown in FIG. 7B. Similarly, first grip ring segment 712b interlocks with second grip ring segment 713c, which in turn interlocks with third grip lock segment 714b.

Grip ring assembly 710 can be secured to handlebar 180 by an inner lock ring 711a and an outer lock ring 719a. Both lock rings 711a, 719a can be further secured to handlebar 180 by set screws 711s, 719s, respectively.

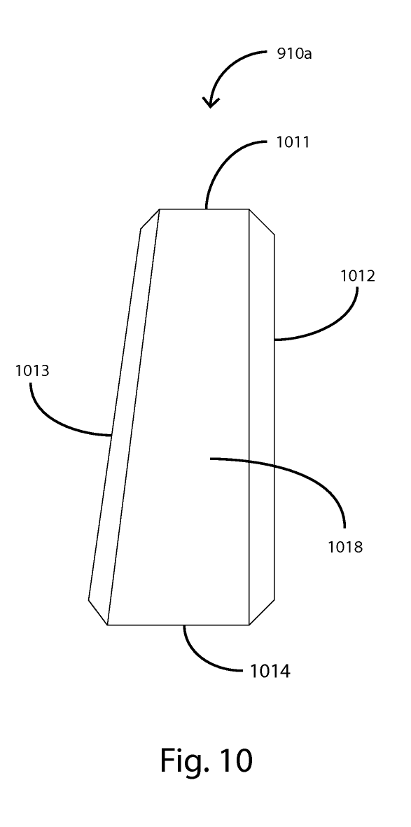

FIG. 9 is a perspective view showing another exemplary configurable handlebar grip assembly 910 having a plurality of grip rings 910a, 910b, 910c . . . 910t. In this embodiment, one or more of grip rings 910a, 910b, 910c . . . 910t is an angled grip ring, e.g., angled grip ring 910a whose wedge-like trapezoidal side profile is illustrated in FIG. 10.

Many different trapezoidal profiles for angled grip rings are possible. For example, angled grip ring 910a includes non-parallel side interfaces 1012, 1013. Side interface 1012 is configured to be installed to handlebar 180 in a substantially perpendicular orientation, while side interface 1013 is configured to be installed to handlebar 180 in an angled orientation.

Angled grip rings such as ring 910a are also useful for installation on curved portions of handlebars, for functional and/or esthetic purposes. By varying the angular offset between adjacent angled grip rings, a wide range of handlebar curvatures may be accommodated.

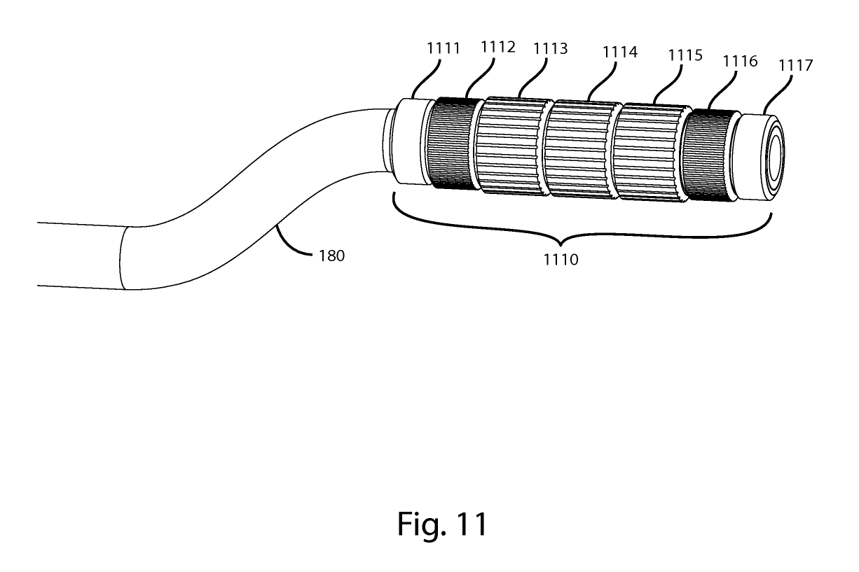

FIG. 11 is a perspective view showing another embodiment of a configurable hybrid handlebar grip assembly 1110 with a variety of grip rings 1111, 1113, 1114, 1115 and 1116 installed on a handlebar 180. In this embodiment, the grips ring sequence transitions from a grip ring 1111 having a smaller external diameter to a grip ring 1112 having a medium external diameter to several grip rings 1113, 1114, 1115 having larger external diameters, and then back to grip ring 1116 having a medium external diameter, and ending with a grip ring 1117 having a smaller external diameter, thereby creating a grip ring assembly 1110 with a unique external profile and/or texture.

It can be appreciated that other suitable materials for forming grip rings of the above described embodiments, e.g., grip ring assemblies 110, 410, 510, 610, 710, 910 and 1110, include silicon-based materials, thermoset rubber compounds, thermoplastic rubbers, and natural materials such as cork. It is also possible to mix and match materials with different properties. Examples include mixing pliable materials with less pliable materials, or mixing a polypropylene inner ring with an outer over-molded TPE (Thermoplastic Elastomer) ring.

It is also contemplated that the above described grip ring assemblies are useful for a wide variety of pedicycles, including unicycles, bicycles, tricycles, and quadcycles. Further, these pedicycles can be human-powered and/or motorized.

Many modifications of the above described embodiments are also possible. For example, while the external profiles of most of these embodiments are substantially circular, it is also possible for grip rings to have a circular internal profile with a polygonal external profile.

For ease of installation, as well as other advantages discussed above, it will be beneficial to have grip assemblies constructed from multiple, independent rings. Installation of a single ring is much easier than installing a full or half length grip. This is because a single ring is easier to stretch and has less sliding friction than a full-length grip. Another advantage of a grip made of independent rings would be that it allows the user to customize grip length, color, texture, and shape along the axis of the grip. Users with small hands or shorter bars can install fewer rings for a short grip, while users with large hands can install more rings to create a longer gripping surface. The exemplary embodiments described above allow users to personalize their grips to better match their hand shape, gripping surface and aesthetic preferences. Users can advantageously replace only sections of a grip in the event that regions of the grip are worn or damaged instead of replacing the entire grip pair.

While this invention has been described in terms of several embodiments, there are alterations, modifications, permutations, and substitute equivalents, which fall within the scope of this invention. Hence, it should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A configurable handlebar grip assembly useful in associate with a handlebar of a pedicycle, the grip assembly comprising at least three stretchable grip rings, wherein a width of each of the grip rings is substantially shorter than half of a desired grip length of the handlebar, and wherein an internal diameter of each grip ring is smaller than an external diameter of the handlebar.

2. The handlebar grip assembly of claim 1 wherein the pedicycle is a one of a unicycle, a bicycle, and a tricycle, and a quadcycle.

3. The handlebar grip assembly of claim 1 wherein the pedicycle is motorized.

4. The handlebar grip assembly of claim 1 wherein the internal diameter of each grip ring is approximately 95% or less of the external diameter of the handlebar.

5. The handlebar grip assembly of claim 1 wherein the grip rings are configured to be nested.

6. The handlebar grip assembly of claim 1 wherein the grip rings nest and interlock with adjacent grip rings.

7. The handlebar grip assembly of claim 1 wherein the grip rings overlap in a staggered manner with adjacent rings.

8. The handlebar grip assembly of claim 1 wherein the grip rings are angled.

9. The handlebar grip assembly of claim 1 wherein the grip rings are textured.

10. The handlebar grip assembly of claim 1 wherein the grip rings are colorized.

11. The handlebar grip assembly of claim 1 wherein the grip rings vary in width.

12. The handlebar grip assembly of claim 1 wherein grip rings are chamfered and configured to create grooves when installed.

13. The handlebar grip assembly of claim 1 wherein the outermost grip ring is configured to be held in place by an end cap configured to be securely coupled to an end of the handlebar.

14. The handlebar grip assembly of claim 1 further comprising at least one lock ring configured to substantially prevent at least one of the grip rings from shifting axially with respect to the handlebar.
